(19) United States
(12) Patent Application Publication
(10) Pub. No.: US 2024/0342634 A1
(43) Pub. Date: Oct. 17, 2024

(54) FILTER MONITORING

(71) Applicant: John Crane UK Limited, Slough (GB)

(72) Inventors: Edgar Alexander Hugo Allanwood, Shetland (GB); Cyrille Philippe LEVESQUE, Chicago, IL (US)

(21) Appl. No.: 18/631,609

(22) Filed: Apr. 10, 2024

Related U.S. Application Data
(60) Provisional application No. 63/458,538, filed on Apr. 11, 2023.

(51) Int. Cl. B01D 35/143; C02F 1/00

(52) U.S. Cl. CPC B01D 35/143; C02F 1/008

(57) ABSTRACT

Systems and methods for monitoring a liquid filter. The method includes: passing liquid through a filter contained within a housing; providing light into the filter; receiving reflected light from the filter, analyzing the reflected light with a spectrometer, and determining that the filter should be cleaned or repaired based on rate of change of a color of the reflected light.

### CROSS REFERENCE TO RELATED APPLICATION

This application claims the benefit of an earlier filing date from U.S. Provisional Application Ser. No. 63/458,538 filed Apr. 11, 2023, the entire disclosures of both which are incorporated herein by reference.

### BACKGROUND

Exemplary embodiments pertain to the art of filters and, in particular, to monitoring filters for use in cleaning lubricant (e.g., oil) used in in a mechanical machine.

Machines typically include one or more lubrication sources such as a hydrocarbon fluid. Hydrocarbon fluids can undergo various stresses in lubricating processes that can cause it to degrade. This degradation results in the formation of less soluble degraded components that can be either dissolved or suspended depending upon the chemistry and temperature of the hydrocarbon fluid. When the degraded components are in a suspended state, they can settle out of solution and can disadvantageously form deposits, often referred to as varnish, in the system. The formation of the varnish can be significant, especially in cooler sections or in low-flow sections of lubrication systems and can form significant build-up on infrequently used components such as servo-valves risking their performance, reliability, or safety of the entire system.

While technologies, such as electrostatic oil cleaning and depth media filters, have been developed to remove these components, they have only achieved moderate success. Further, it is difficult to know when certain portions of the filter have passed their useful life.

### BRIEF DESCRIPTION

Disclosed are systems and methods to monitor resin-based filters.

According to embodiment, a method of monitoring a liquid filter is disclosed. The method includes: passing liquid through a filter contained within a housing; providing light into the filter; receiving reflected light from the filter; analyzing the reflected light with a spectrometer; and determining that the filter should be cleaned or repaired based on rate of change of a color of the reflected light.

According any prior embodiment, determining can include determining that the rate of change has stopped changing below a threshold.

According any prior embodiment, analyzing can occur while the passing liquid.

According any prior embodiment, the method can further include stopping passing liquid and the analyzing occurs after stopping passing the liquid.

According any prior embodiment, the light can be white light.

According any prior embodiment, the reflected light can be analyzed by a spectrometer on a chip.

According any prior embodiment, the light can be provided into the filter via a fiber optic cable.

According any prior embodiment, the fiber optic cable can include a one or more illumination fibers and one or more return fibers.

According any prior embodiment, the light can be provided into the filter by the one or more illumination fibers, is reflected from a resin in the filter and provided to the spectrometer via the one or more return fibers.

According any prior embodiment, the one or more illumination fibers can be surround the one or more return fibers.

Also disclosed is a system for monitoring a liquid filter. The system can include a filter contained within a housing through which passing liquid through and a filter measurement system. The measurement system can also include a cable for providing light into the filter and receiving reflected light from the filter, a spectrometer for analyzing the reflected light and a controller for determining that the filter should be cleaned or repaired based on rate of change of a color of the reflected light.

According to any prior embodiment, the controller can determine that the rate of change has stopped changing below a threshold.

According to any prior embodiment, the analyzing can occur while liquid is being passed through the filter.

According to any prior embodiment, the analyzing can occur after liquid has being passed through the filter.

According to any prior embodiment, the light can be white light.

According to any prior embodiment, the spectrometer can be a spectrometer on a chip.

According to any prior embodiment, the cable can be a fiber optic cable that includes a one or more illumination fibers and one or more return fibers.

According to any prior embodiment, light can be provided into the filter by the one or more illumination fibers, is reflected from a resin in the filter and provided to the spectrometer via the one or more return fibers.

According to any prior embodiment, the one or more illumination fibers can be surround the one or more return fibers.

### BRIEF DESCRIPTION OF THE DRAWINGS

The following descriptions should not be considered limiting in any way. With reference to the accompanying drawings, like elements are numbered alike:

FIG. 1 shows an example of a gas filtration system that can include one or more embodiments;

FIG. 2 shows an example of a portion of sensor that can be utilized in embodiments;

FIG. 3 shows a graph of color change versus time for sensors placed at certain locations; and

FIG. 4 is a flow chart of a method according to one embodiment.

### DETAILED DESCRIPTION

A detailed description of one or more embodiments of the disclosed apparatus and method are presented herein by way of exemplification and not limitation with reference to the Figures.

Many prior filters assemblies include one or more filter housings and generally work well for their intended purposes Each housing surrounds a filter element that removes varnish from a liquid such as lubricating oil. These filter elements can include a hollow inner region surround by a filter medium that removes the liquid.

In more detail, embodiments are directed to systems/method of determining when a varnish removal filter has reached or is reaching an end of useful life. By way of further background, it is noted that varnish is sticky contamination of lubricating oil caused by thermal or oxidative stress and can stick to cooler areas of machines, clogging valves and reducing clearances. Varnish exists in two states: soluble (liquid) and insoluble (sub-micron particles) and the proportion of each is temperature dependent When soluble varnish is filtered out, insoluble varnish that is stuck to surfaces may re-dissolve meaning there is no immediate change

The industry standard (ASTM D7843) way of measuring varnish is a filter is by running an oil-ether mix through a filter membrane patch, drying it and measuring the color difference to a patch run through with clean oil. Such a test is called a membrane patch colorimetry (MPC) test. While such tests are effective, they require shutting down the filter to perform the test. The disclosed methods can make a similar determination without having to shut down the filter.

In one embedment, the system includes a spectrophotometer. A spectrophotometer is an instrument used to measure the color difference in the reflections. In particular, one or more light sources provide light to the resin in the filter while the filter is operating. The light can be white light provided by, for example, optical fibers. This light can be directed to the filter and then reflections gathered. The reflections can be gathered by another optical fiber, for example, and provided back to the spectrophotometer. The spectrophotometer can be on a chip in one embodiment. The spectrophotometer can measure color differences. When the color stops changing (or slows to sufficient extent) it can be concluded that a resin is saturated and should be changed. The color change (or delta E) is the calculated difference in the CIE Lab color space from a clean patch sample to a dirty one.

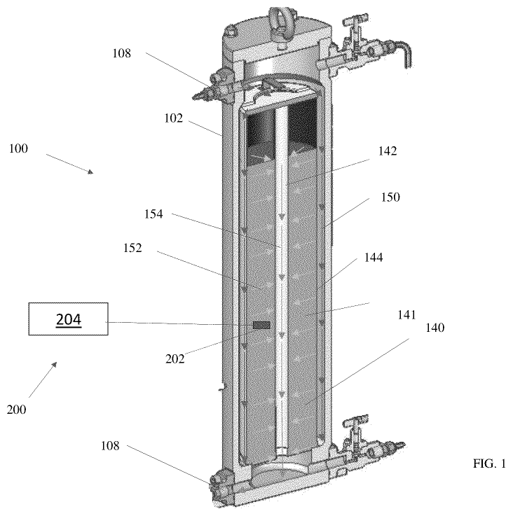

To further illustrate embodiments liquid filtration system (or filter assembly) 100 is shown in FIG. 1. The filter assembly could be, for example, a skid or other element used to filter lubrication oil for a rotating machine such as compressor.

The filter assembly 100 includes a filter housing 102. Embodiments herein can include a filter assembly that includes a single filter housing or more than two filter housings. When two filter housings are provided, the filter assembly 100 may be referred to as duplex filter assembly. Regardless of the configuration, the filter assembly includes an inlet 106 and an outlet 108. In normal operation, liquid enters the filter assembly 100 at the inlet 106 and leaves it at the outlet 108. As the liquid passes from the inlet 106 to the outlet 108 it will pass through any filter in the filter housing 102.

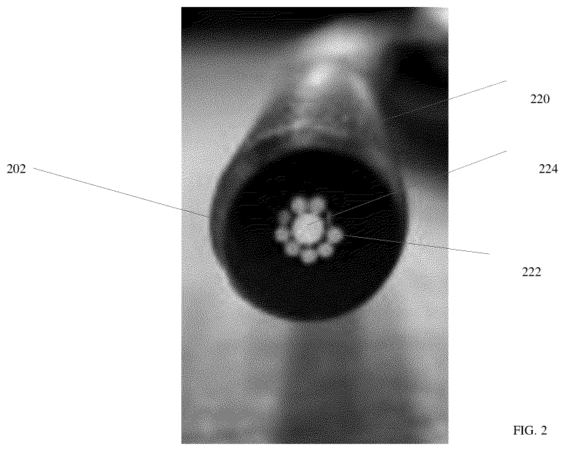

The filter housing 102 includes a filter element 140 disposed therein. In operation, liquid that flows from the inlet 106 to the outlet 108 will pass the filter element 140. The filter element 140 can be cartridge in one embodiment. The filter element 140 includes resin disposed therein. Embodiments here will measure the color of the resin. The resin is generally referred to by reference numeral 141 in FIG. 2 and may be suspended in a filter matrix.

The filter element 140 includes a hollow inner region 142. Liquid initially enters the filter housing 102 it flows downward between the housing 102 and an outer surface 144 of the filter element 140. This is shown generally by downward arrows 150.

Suction or other means may provided to the hollow inner region 142 to cause liquid to move from the outer surface 144 to the hollow inner region 142 as indicated by arrows 152. The liquid then flows out to the outlet 108 as indicated by arrows 154. When passing through the filter element 140, varnish can be removed from the liquid and builds up in the filter 140.

Overtime, varnish may saturate the filter 140 and make is less effective. The inventors hereof have discovered that the more varnish that is adsorbed by the resin, the more the filter element changes color. To that end, a filter monitoring system/method is disclosed herein. The system utilizes it gets a spectrometer to measure changes in color in the resin in the filter 140. In a general sense, when the filter 140 stops changing color by a certain amount, it can be determined that the filter 140 is saturated and should be serviced, cleaned or replaced.

To achieve this, a sensor assembly 200 is provided. The sensor assembly 200 includes a sensing portion 202 disposed in the filter 140 that collects color readings of the resin in the filter 140 during use. The assembly 200 can also include a controller 204 that interprets the collected color information.

FIG. 2 show one example of the sensing portion 202. As shown, the sensing portion 202. The sensing portion 202 can be implemented as an optical fiber bundle in one embodiment that includes illumination fiber(s) that illuminate the resin the filter 140 and return or reflection fiber(s) that carries reflected light back to the controller 220 for analysis.

As shown, the bundle includes an outer casing 220. The casing 220 can include an outer fiber bundle formed of one or more illumination fibers 222. These fibers can carry light (e.g., white light) into the filter 140. The light will contact the filter 140 and be reflected back into a return fiber 224. This light is then provided back to the controller 220 where is change in color is analyzed.

Of course, other means of getting light into and out of the filter 140 could be used. for example, glass or plastic light pipes could be used.

In one embodiment, the controller 204 can be a spectrometer. The spectrometer can be a spectrometer on a chip in one embodiment. The spectrometer can be configured to includes one or windows with narrowband filters on to cover different areas of the spectrum.

In one embodiment, the spectrometer can estimate the spectrum of the returned light (e.g., the color of the filter 140) based via a fitting algorithm and a XYZ color space. In one embodiment, the controller 204 can include programming to convert the color space into a CIE Lab color space.

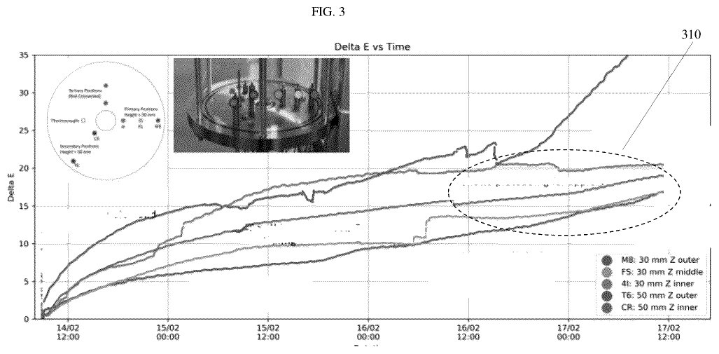

Reference is now made to FIG. 3 which shows results of color change (delta E) for five different test sensors. Each sensor is in different region of the filter during the test and the noted heights are just example locations measured from the bottom of the filter. These results have been empirical compared to the status of filter 140. It has been discovered that the filter should be serviced/replace when delta E generally stops changings. This is shown generally by region 310 in FIG. 3. Delta E can also be referred to as a rate of change of color of the filter.

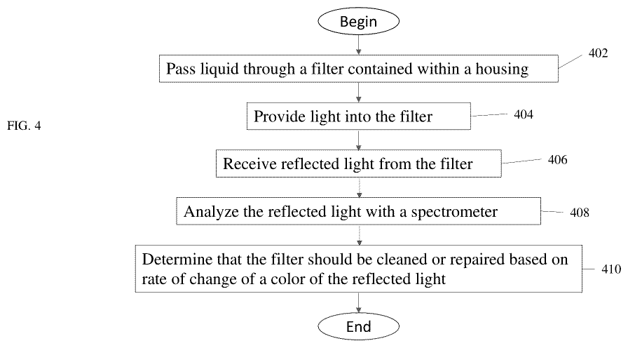

According to the above, it shall be understood that method has been disclosed of monitoring a fluid filter. As shown in FIG. 4, the method can include passing liquid through a filter contained within a housing as indicated at block 402. The liquid can remain flowing or can be stopped. Regardless, as indicated at block 404, the method further includes providing light into the filter. The light can be provided as disclosed herein or by other means. In one embodiment, the light is white light. The light may be produced, for example, by an LED in one embodiment.

As indicated at block 406, the method can also include receiving reflected light from the filter. The light is light that is reflected off filter in one embodiment. As such, the light will have a color. The light can returned by, for example, an optical fiber or by other means.

As indicated at block 408, the method can further include analyzing the reflected light with a spectrometer. The spectrometer can be an IC spectrometer referred to as a spectrometer on a chip in one embodiment.

As indicated at block 408, the method can further include determining that the filter should be cleaned or repaired based on rate of change of a color of the reflected light. This can be done in the controller either by the spectrometer or by another chip but could also be done by other controllers. The determination can include determining that rate of change has stopped changing below a threshold level. This can include, for example, that the color has stopped changing or has only changed a small amount over a period of time.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A method of monitoring a liquid filter, the method comprising:
passing liquid through a filter contained within a housing;
providing light into the filter;
receiving reflected light from the filter;
analyzing the reflected light with a spectrometer; and
determining that the filter should be cleaned or repaired based on rate of change of a color of the reflected light.

2. The method of claim 1, wherein determining includes determining that the rate of change has stopped changing below a threshold.

3. The method of claim 1, wherein the analyzing occurs while the passing liquid.

4. The method of claim 1, further comprising stopping passing liquid and the analyzing occurs after stopping passing the liquid.

5. The method of claim 1, wherein the light is white light.

6. The method of claim 5, wherein the reflected light is analyzed by a spectrometer on a chip.

7. The method of claim 5, wherein the light is provided into the filter via a fiber optic cable.

8. The method of claim 7, wherein the fiber optic cable includes a one or more illumination fibers and one or more return fibers.

9. The method of claim 8, wherein light is provided into the filter by the one or more illumination fibers, is reflected from a resin in the filter and provided to the spectrometer via the one or more return fibers.

10. The method of claim 9, wherein the one or more illumination fibers are surround the one or more return fibers.

11. A system for monitoring a liquid filter, the system includes:
a filter contained within a housing through which passing liquid through;
a filter measurement system that includes:
a cable for providing light into the filter and receiving reflected light from the filter;
a spectrometer for analyzing the reflected light; and
a controller for determining that the filter should be cleaned or repaired based on rate of change of a color of the reflected light.

12. The system of claim 11, wherein controller determines that the rate of change has stopped changing below a threshold.

13. The system of claim 11, wherein the analyzing occurs while liquid is being passed through the filter.

14. The system of claim 11, wherein the analyzing occurs after liquid has being passed through the filter.

15. The system of claim 11, wherein the light is white light.

16. The system of claim 11, wherein the spectrometer is a spectrometer on a chip.

17. The system of claim 11, wherein the cable is a fiber optic cable that includes a one or more illumination fibers and one or more return fibers.

18. The system of claim 17, wherein light is provided into the filter by the one or more illumination fibers, is reflected from a resin in the filter and provided to the spectrometer via the one or more return fibers.

19. The system of claim 18, wherein the one or more illumination fibers are surround the one or more return fibers.
